(19) United States
(12) Patent Application Publication
(10) Pub. No.: US 2005/0052085 A1
(43) Pub. Date: Mar. 10, 2005

(54) Uninterruptible power supply circuit having hot swappable battery module

(76) Inventors: Herlin Chang, Township (TW); Min-Huang Huang, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,948

(22) Filed: Sep. 4, 2003

(51) Int. Cl. H02J 7/00

(52) U.S. Cl. 307/66

(57) ABSTRACT

An improved uninterruptible power supply circuit having a hot swappable battery module is connected with internal connectors of a UPS power supply circuit via external connectors of the power supply circuit. When the supply of the commercial AC power is abnormal, the backup battery provides power to the power supply circuit via the internal connectors in response to signals from the UPS power supply circuit, thereby instantly providing power to the computer and avoiding power interruption, wherein the backup battery is provided in a removable battery box, and several backup batteries can be connected in parallel by means of the removable battery box so as to provide power to the computer in case of long-term power failure.

### BACKGROUND OF THE INVENTION

1. Field of the Invention

This invention relates to an improved uninterruptible power supply circuit having a hot swappable battery module, which is connected with internal connectors of a UPS power supply circuit via external connectors of the power supply circuit. The UPS power supply circuit can be separated from the battery system, and several UPS power supply circuits can be connected in parallel, thereby increasing UPS capacity. When the UPS power supply circuit malfunctions, the other UPS power supply circuits continuously operate in order to increase reliability of the computer system.

When the commercial AC power is inputted, the UPS power supply circuit activates the AC detecting and charging circuit by means of the UPS controlling and circuit managing system, when the supply of the commercial AC power is normal, the battery detecting circuit transmits a signal to the charging circuit, thereby charging the backup battery, when the charging operation is completed, the charging circuit automatically interrupts the operation of the charging circuit, thereby avoiding damage of the backup battery due to saturation of the backup battery; the UPS controlling and circuit managing system transmits a signal to the AC detecting and charging circuit, the AC detecting and charging circuit is connected to the power supply circuit via the internal connector, thereby detecting anytime whether the supply of the commercial AC power is normal, when the supply of the commercial AC power is abnormal, by means of the DC TO DC boosting circuit, the UPS power supply circuit instantly uses the power of the backup battery to provide a stable current to the power supply circuit via the internal connector, thereby instantly providing power to maintain normal operation of the computer.

2. Description of the Prior Art

Nowadays, the prevalence of a computer provides convenient lifestyles and rapid data transmission for us. However, due to a very long power line and a complex power network for supplying the commercial AC power to the computer, the commercial AC power is very sensitive to many variations such as under-voltage, over-voltage, inruch, noise, distorted waveform, frequency variation, etc, which severely impair the power stability and quality. In particular, for a computer which requests high stability, sudden variations may lead to damage, crash or even breakdown of the computer. The service cost thereof is unexpectedly high accordingly. On the other hand, although the failure of hardware can be overcome by means of maintenance or replacement of components, the lost data stored therein are invaluable and hard to be refreshed.

The so-called uninterruptible power supply, referred hereinafter to UPS, becomes essential equipment for a computer. The commercially available UPS apparatuses are divided into on-line and off-line configurations. Although the on-line UPS apparatus can be installed on the housing of the computer so as to make use of space, it is difficult to be disassembled/assembled. When the battery for providing power of the UPS apparatus malfunctions, the housing of the computer needs to be opened in order to change the battery therein. Furthermore, an example of an off-line UPS apparatus is a removable UPS apparatus described in Taiwanese Patent Application No. 483626. Although such off-line UPS apparatus is easily disassembled/assembled for changing batteries, the power needs to be switched off and the UPS power and battery module thereof are not hot swappable, which is not user-friendly.

Thus, when the power of the battery malfunctions, either the on-line or the off-line configuration should interrupt power supply of the computer in order to replace battery. After the battery is replaced, the computer can be restarted, which adversely affects power stability and quality.

Accordingly, the above-described prior art product is not a perfect design and has still many disadvantages to be solved. In views of the above-described disadvantages resulted from the conventional rotary safety cutter, the applicant keeps on carving unflaggingly to develop an improved uninterruptible power supply circuit having a hot swappable battery module according to the present invention through wholehearted experience and research.

### SUMMARY OF THE INVENTION

An object of the invention is to provide an improved uninterruptible power supply circuit having a hot swappable battery module, which can be connected with several UPS power supply circuits in parallel so as to maintain normal operation of the computer in case of long-term power failure.

Another object of the invention is to provide an improved uninterruptible power supply circuit having a hot swappable battery module, which can be connected with at least one removable battery box so as to maintain normal operation of the computer in case of long-term power failure.

Another object of the invention is to provide an improved uninterruptible power supply circuit having a hot swappable battery module, in which the UPS power supply circuit can instantly realize supply conditions of the commercial AC power via connectors so as to provide power of the backup battery.

A still another object of the invention is to provide an improved uninterruptible power supply circuit having a hot swappable battery module, in which by means of hot swappable batteries, the batteries can be replaced without switching off the computer.

The present invention relates to an improved uninterruptible power supply circuit having a hot swappable battery module, which comprises a UPS power supply circuit for providing power of a backup battery to a load via connectors, wherein the backup battery provides power to the load by parallel connection of removable battery boxes.

### BRIEF DESCRIPTION OF THE DRAWINGS

The drawings disclose an illustrative embodiment of the present invention which serves to exemplify the various advantages and objects hereof, and are as follows:

FIG. 1 is a block diagram of a power supply circuit according to the present invention;

FIG. 2 is a block diagram of a UPS power supply circuit according to the present invention;

FIG. 3 is a schematic view of a removable battery box according to the present invention;

FIG. 4 is a diagram illustrating a first embodiment of the present invention; and

FIG. 5 is a diagram illustrating a second embodiment of the present invention.

### DETAILED DESCRIPTION OF THE PREFERRED EMBODIMENT

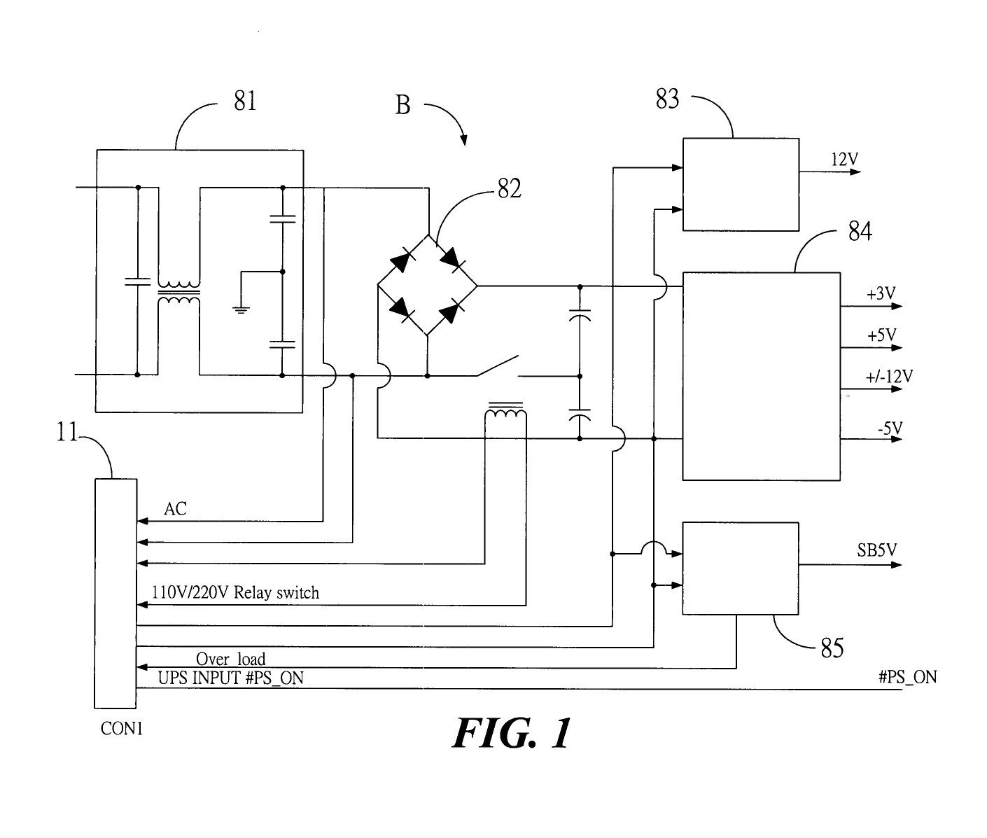

FIG. 1 illustrates an improved uninterruptible power supply circuit having a hot swappable battery module, wherein the power supply circuit B comprises essentially of:

a voltage regulator circuit 81, comprising at least a rectifier circuit 82 for accepting power, filtering and converting the power into a direct current to be outputted;

a DC TO DC converting circuit 84;

an external power 83;

a standby power 85;

a computer power switch 86; and

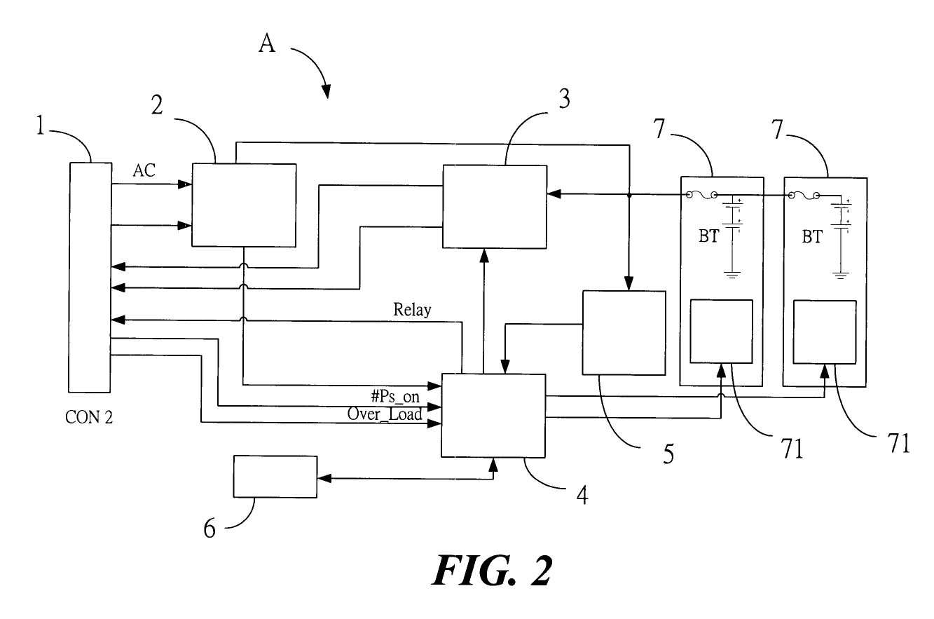

an external connector 11, connected to power supply signals, load signals, computer power switch 86 signals and relay switch signals, respectively, and connected with the internal connector 1 of the UPS power supply circuit A (FIG. 2), such that the UPS power supply circuit A realizes supply conditions of the commercial AC power via the internal connector 1. Accordingly, when the supply of the commercial AC power is abnormal, the UPS power supply circuit A can instantly provide power to the computer so as to maintain normal operation of the computer.

FIG. 2 illustrates an improved uninterruptible power supply circuit having a hot swappable battery module, wherein the UPS power supply circuit A comprises essentially of:

an internal connector 1, connected with the external connector 11 of the power supply circuit B;

an AC detecting and charging circuit 2, for detecting whether the supply of the commercial AC power is normal and charges to the backup battery 7 via the external connector 11;

a battery detecting circuit 5, for detecting whether the power of the backup battery 7 is sufficient, wherein when the power of the backup battery 7 is full, the charging circuit of the AC detecting and charging circuit 2 is switched off;

a backup battery 7, provided in a removable battery box 7A, wherein the backup battery 7 is charged by the AC detecting and charging circuit 2;

a monitoring signal 6, for displaying a control signal;

a DC TO DC boosting circuit 3, connected to the external connector 11 of the power supply circuit B via the internal connector 1, and instantly providing power to the voltage regulator circuit 81 when the supply of the commercial AC power is abnormal, thereby maintaining normal operation of the voltage regulator circuit 81;

a UPS controlling and circuit managing system 4, for controlling signals from the power supply circuit B, the UPS power supply circuit A and the removable battery box 7A;

wherein when the commercial AC power is inputted, the UPS power supply circuit A activates the AC detecting and charging circuit 2 by means of the UPS controlling and circuit managing system 4, when the supply of the commercial AC power is normal, the battery detecting circuit 5 transmits a signal to the AC detecting and charging circuit 2, thereby detecting and charging the backup battery 7, when the charging operation is completed, the AC detecting and charging circuit 2 automatically interrupts the operation of the charging circuit, thereby avoiding damage of the backup battery 7 due to saturation of the backup battery 7; the UPS controlling and circuit managing system 4 transmits a signal to the AC detecting and charging circuit 2, and the AC detecting and charging circuit 2 is connected to the external connector 11 of the power supply circuit B via the internal connector 1, thereby detecting anytime whether the supply of the commercial AC power is normal, when the supply of the commercial AC power is abnormal, by means of the DC TO DC boosting circuit 3, the UPS power supply circuit A instantly uses the power of the backup battery 7 to provide a stable current to the power supply circuit B via the internal connector 1, thereby instantly providing power to maintain normal operation of the computer.

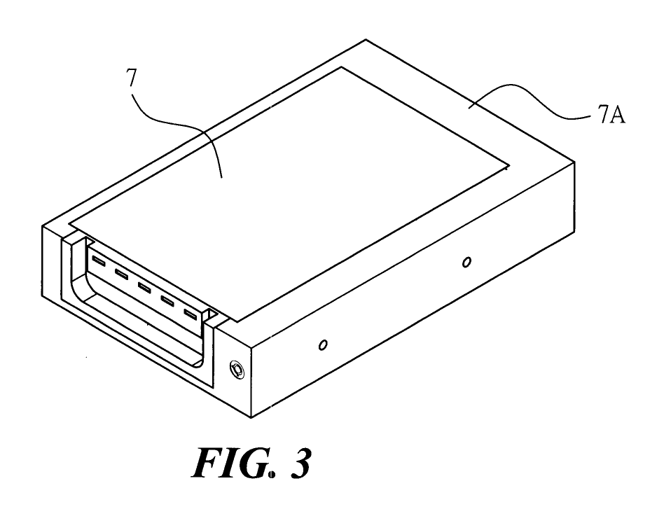

FIG. 3 illustrates an improved uninterruptible power supply circuit having a hot swappable battery module, wherein the removable battery box 7A has therein the backup battery 7, and the removable battery box 7A is provided thereon with an inserting terminal, wherein a contact element extends from the front end of the inserting terminal, and the contact element is connected with the UPS power supply circuit A and provides the power to the computer by the UPS controlling and circuit managing system 4 of the UPS power supply circuit A, wherein the removable battery box 7A can be provided with a handle for facilitating drawing-out/installing the removable battery box 7A during the hot swapping operation. Furthermore, each of the bilateral sides of the removable battery box 7A can be provided with a gliding track for facilitating easily positioning and smoothly drawing-out/installing the removable battery box 7A during the hot swapping operation.

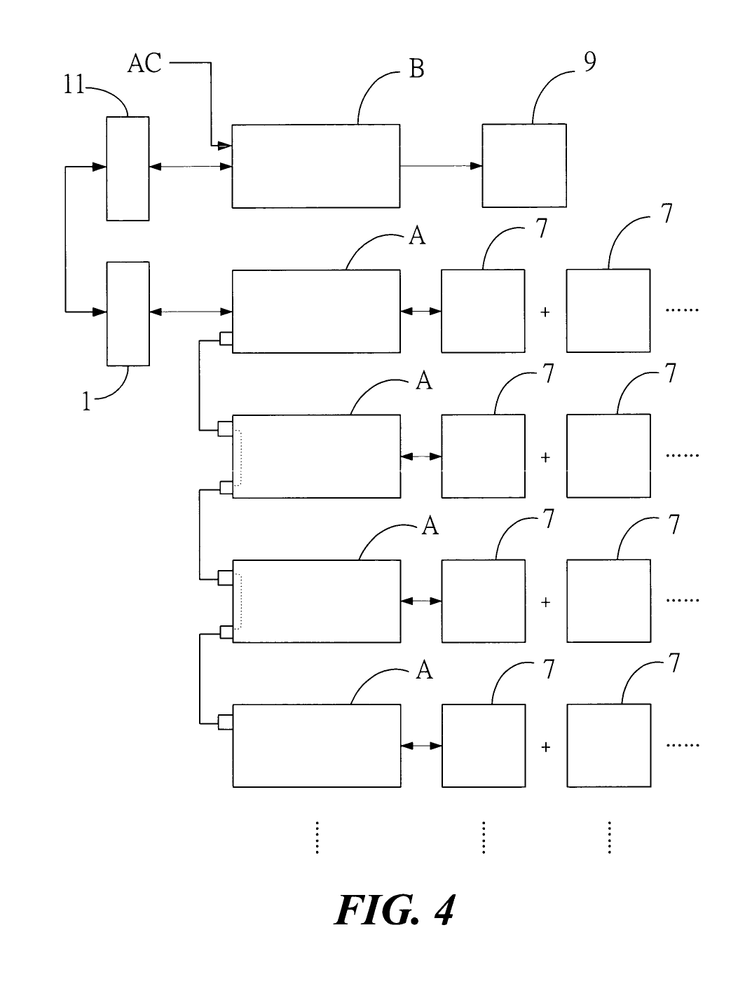

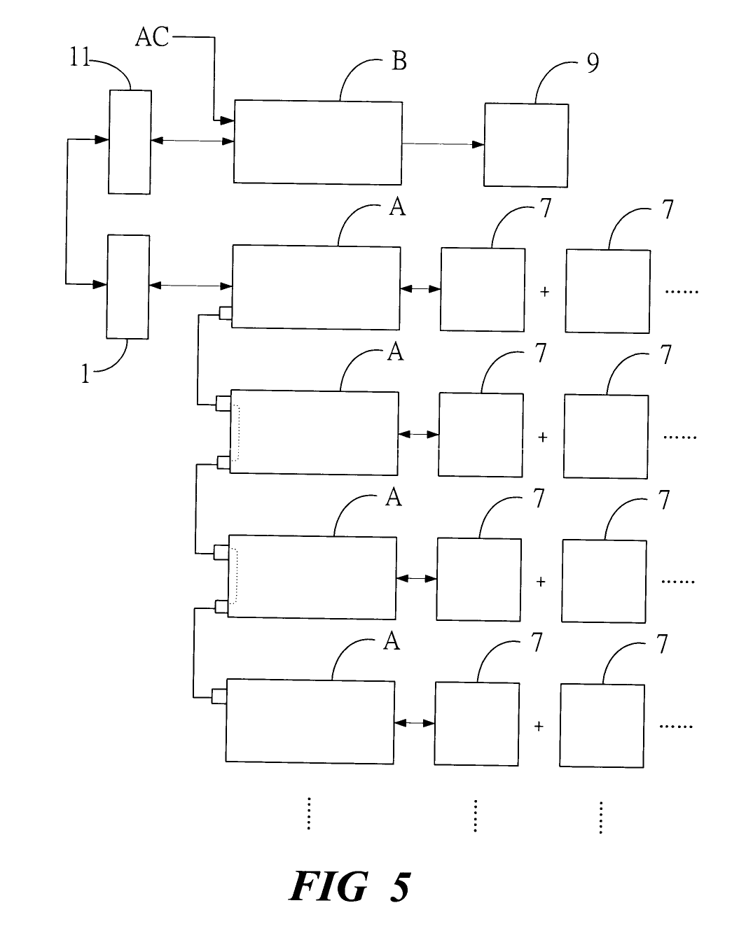

FIGS. 4 and 5 illustrate embodiments of an improved uninterruptible power supply circuit B having a hot swappable battery module. The power supply circuit B of the computer 9 is connected to one or more internal connectors 1 of the UPS power supply circuit A via the external connector 11, and they are connected in parallel so as to maintain normal operation in case of long-term power failure. Furthermore, another UPS power supply circuit A can be drawn out/installed in a hot swappable mode without switching off the computer 9, such that the battery of the computer 9 can be replaced without switching off the computer 9.

The improved uninterruptible power supply circuit having a hot swappable battery module, when comparing with other previous conventional technologies, has following advantages:

1. The present invention uses connectors to connect the UPS power supply circuit and the power supply circuit, and uses the AC detecting and charging circuit to realize AC power conditions and instantly provides the power of the backup battery in case of abnormal power condition.

2. The present invention uses connectors to connect the power supply circuit with one or more UPS power supply circuits so as to maintain normal operation in case of long-term power failure.

3. By means of parallel connection and fault tolerance, the UPS power supply circuit is connected with at least one backup battery in parallel, and via power lines of the removable battery box in serial/parallel connection so as to expand shelf life thereof.

4. By means of the parallel connection, the UPS power supply circuit and the removable battery box can be drawn out/installed without switching off the computer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. An improved uninterruptible power supply circuit having a hot swappable battery module, comprising a UPS power supply circuit for providing power of a backup battery to a load via connectors, wherein said backup battery provides power to said load by parallel connection of removable battery boxes.

2. An improved uninterruptible power supply circuit having a hot swappable battery module, comprising essentially of:
a power supply circuit, comprising at least an external connector connected with internal connectors, wherein backup power of said internal connectors instantly provides power to a computer when external power is abnormal;
a UPS power supply circuit, comprising at least an internal connector connected with said external connector, wherein backup power of said internal connectors instantly provides power to said computer when external power is abnormal, wherein one end thereof is connected to a backup battery; and
a removable battery box, comprising said backup battery disposed therein for providing power to said circuits and said computer;
wherein said power supply circuit is connected to said internal connector of said UPS power supply circuit via said external connector thereof for providing commercial AC power to said computer via said power supply circuit, and when said commercial AC power is abnormal, said backup battery of said UPS power supply circuit instantly provides power to said computer via said internal connector, thereby maintaining normal operation of said computer.

3. The improved uninterruptible power supply circuit having a hot swappable battery module according to claim 2, said power supply circuit comprising essentially of:
a voltage regulator circuit, comprising at least a rectifier circuit for accepting power, filtering and converting said power into a direct current to be outputted;
a DC TO DC converting circuit;
a standby power;
a computer power switch; and
an external connector, connected to power supply signals, load signals, computer power switch signals and relay switch signals, respectively, and connected with said internal connector, such that said UPS power supply circuit instantly realizes supply conditions of said commercial AC power via said internal connector, thereby instantly providing power to said computer to maintain normal operation of said computer when the supply of said commercial AC power is abnormal.

4. The improved uninterruptible power supply circuit having a hot swappable battery module according to claim 2, said UPS power supply circuit comprising essentially of:
an internal connector connected with said external connector of said power supply circuit;
an AC detecting and charging circuit for detecting whether the supply of said commercial AC power is normal and charges to said backup battery via said external connector;
a battery detecting circuit for detecting whether the power of said backup battery is sufficient, wherein when the power of said backup battery is full, said charging is switched off;
a backup battery provided in said removable battery box, wherein said backup battery is charged by said charging circuit;
a monitoring signal;
a DC TO DC boosting circuit, connected to said power supply circuit via said internal connector, and instantly providing power to said voltage regulator circuit when the supply of said commercial AC power is abnormal, thereby maintaining normal operation of said voltage regulator circuit;
a UPS controlling and circuit managing system for controlling signals from said power supply circuit, said UPS power supply circuit and said removable battery box;
wherein when said commercial AC power is inputted, said UPS power supply circuit activates said AC detecting and charging circuit by means of said UPS controlling and circuit managing system, when the supply of said commercial AC power is normal, said battery detecting circuit transmits a signal to said charging circuit, thereby charging said backup battery, when the charging operation is completed, said charging circuit automatically interrupts the operation of said charging circuit, thereby avoiding damage of said backup battery due to saturation of said back-up battery; said UPS controlling and circuit managing system transmits a signal to said AC detecting and charging circuit, said AC detecting and charging circuit is connected to said power supply circuit via said internal connector, thereby detecting anytime whether the supply of said commercial AC power is normal, when the supply of said commercial AC power is abnormal, by means of said DC TO DC boosting circuit, said UPS power supply circuit instantly uses the power of said backup battery to provide a stable current to said power supply circuit via said internal connector, thereby instantly providing power to maintain normal operation of said computer.

5. The improved uninterruptible power supply circuit having a hot swappable battery module according to claim 2, wherein said removable battery box has therein said backup battery and provided thereon with an inserting terminal, wherein a contact element extends from the front end of said inserting terminal, and said contact element is connected with the UPS power supply circuit and provides the power to said computer by said UPS controlling and circuit managing system of said UPS power supply circuit.

6. The improved uninterruptible power supply circuit having a hot swappable battery module according to claim 2, wherein said removable battery box is provided on said computer by means of parallel connection and fault tolerance, thereby providing power to said computer in case of long-term power failure.

7. The improved uninterruptible power supply circuit having a hot swappable battery module according to claim 2, wherein said removable battery box is provided with a display light for displaying power statuses, wherein said display light is a light emitting diode (LED).

8. The improved uninterruptible power supply circuit having a hot swappable battery module according to claim 2, wherein said removable battery box is provided with a handle for facilitating drawing-out/installing said removable battery box during the hot swapping operation.

9. The improved uninterruptible power supply circuit having a hot swappable battery module according to claim 2, wherein each of the bilateral sides of said removable battery box is provided with a gliding track for facilitating easily positioning and smoothly drawing-out/installing said removable battery box during the hot swapping operation.

10. The improved uninterruptible power supply circuit having a hot swappable battery module according to claim 2, wherein said removable battery box has positive and negative terminals to be connected with another removable battery box in parallel, thereby maintaining normal operation of said computer in case of long-term power failure.
